(19) United States
(12) Patent Application Publication
(10) Pub. No.: US 2016/0021689 A1
(43) Pub. Date: Jan. 21, 2016

(54) METHOD FOR CONNECTING WIRELESS TERMINAL TO VEHICLE

(71) Applicant: Hyundai Motor Company, Seoul (KR)

(72) Inventor: Jong Ha Moon, Seoul (KR)

(21) Appl. No.: 14/562,717

(22) Filed: Dec. 7, 2014

(30) Foreign Application Priority Data
Jul. 17, 2014 (KR) 10-2014-0090551

(51) Int. Cl. H04W 76/02; H04W 12/06; H04W 4/00; H04L 29/08

(52) U.S. Cl. CPC H04W 76/023; H04L 67/12; H04W 12/06; H04W 4/008; H04W 88/02

(57) ABSTRACT

A method for connecting a wireless terminal to a vehicle includes checking a wired connection or a wireless connection between an infortainment system of the vehicle and the wireless terminal, recognizing identification of the wireless terminal, determining whether or not the wireless terminal is authenticated and thus suitable for connection with the infortainment system, and connecting the wireless terminal to the infortainment system only in a case in which the wireless terminal is authenticated based on a result of the determining of whether or not the wireless terminal is authenticated.

### CROSS-REFERENCE TO RELATED APPLICATION

This application claims the benefit of and priority to Korean Patent Application No. 10-2014-0090551, filed on Jul. 17, 2014 in the Korean Intellectual Property Office, the disclosure of which is incorporated herein in its entirety by reference.

### TECHNICAL FIELD

The present disclosure relates to a method for connecting a wireless terminal to a vehicle, and more particularly, to a method for connecting a wireless terminal to a vehicle in which the wireless terminal is authenticated by an authentication process.

### BACKGROUND

In accordance with recent developments regarding portable smart devices, wireless terminals which may be wirelessly connected to a head unit (H/U) of a vehicle have been developed. A wireless terminal may be connected to the head unit of a vehicle, such that a passenger of the vehicle may share applications, media contents, and the like with another passenger using the wireless terminal through a speaker or a display device in the vehicle.

In addition, the wireless terminal itself may be manipulated by an inputting device included in the head unit. To this end, a connection for transmitting data between the vehicle and the smart device may be required. Specifically, the wireless terminal (e.g., an iPod-iPad/aux, Ford Sync, or the like) and the head unit of the vehicle can be connected through, e.g., a universal serial bus (USB), Bluetooth, or the like, such that data transmission can occur.

However, the above-mentioned connection method necessarily requires a predetermined manipulation of the wireless terminal and the head unit of the vehicle. That is, in order to connect the wireless terminal to the head unit, initial operations by the user are required.

### SUMMARY

The present disclosure has been made to solve the above-mentioned problems occurring in the related art, while advantages achieved by the related art are maintained intact.

An aspect of the present disclosure provides a method for connecting a wireless terminal to a vehicle capable of authenticating the wireless terminal and providing an application to be connected to a head unit that is installed on the wireless terminal based on an authentication result. An aspect of the present disclosure also provides a method for connecting a wireless terminal to a vehicle capable of securing compatibility of a connection with the wireless terminal in the vehicle having a product launch cycle relatively longer than that of the wireless terminal.

According to an exemplary embodiment of the present disclosure, a method for connecting a wireless terminal to a vehicle includes: checking a wired connection or a wireless connection between an infortainment system of the vehicle and the wireless terminal; recognizing identification of the wireless terminal; determining whether or not the wireless terminal is authenticated and thus suitable for connection with the infortainment system; and connecting the wireless terminal to the infortainment system only in a case in which the wireless terminal is authenticated based on a result of the determining of whether or not the wireless terminal is authenticated.

The determining of whether or not the wireless terminal is authenticated may include at least one of: checking whether or not the wireless terminal includes a specification which is connectable to the infortainment system; checking an operating system (O/S) of the wireless terminal; checking whether or not the wireless terminal is or has been hacked or routed; and checking whether or not a dedicated application (app) for connection with the infortainment system is installed in the wireless terminal.

The determining of whether or not the wireless terminal is authenticated may include: transmitting the recognized identification to an authentication server; determining, by the authentication server, whether or not the wireless terminal is authenticated and thus suitable for connection with the infortainment system; and transmitting, to the infortainment system, the result of the determining of whether or not the wireless terminal is authenticated.

The method may further include, in a case in which a dedicated application for connection with the infortainment system is not installed in the wireless terminal: transmitting a message including a dedicated uniform resource locator (URL) for installing the dedicated application in the wireless terminal; checking whether or not the dedicated application is installed in the wireless terminal; and updating the result of the determining of whether or not the wireless terminal is authenticated based on a result of the checking of whether or not the dedicated application is installed in the wireless terminal.

The recognized identification or the result of the determining of whether or not the wireless terminal is authenticated may be transmitted to the authentication server through a gateway provided or managed by a manufacturing company of the vehicle.

The determining of whether or not the wireless terminal is authenticated may include: determining whether or not the wireless terminal is authenticated and thus suitable for connection with the infortainment system, using an authentication database included in the infortainment system.

The determining of whether or not the wireless terminal is authenticated may further include, in a case in which the wireless terminal h is not authenticated: transmitting the recognized identification to an authentication server; determining, by the authentication server, whether or not the wireless terminal is authenticated and thus suitable for connection with the infortainment system; and transmitting, to the infortainment system, the result of the determining of whether or not the wireless terminal is authenticated.

The method may further include, in a case in which a dedicated application for connection with the infortainment system is not installed in the wireless terminal: transmitting the dedicated application to the infortainment system; and transferring the transmitted dedicated application from the infortainment system to the wireless terminal such that the dedicated application is installed in the wireless terminal.

The method may further include: checking whether or not the dedicated application is installed in the wireless terminal; and updating the result of the determining of whether or not the wireless terminal is authenticated based on a result of the checking of whether or not the dedicated application is installed in the wireless terminal.

The recognized identification or the result of the determining of whether or not the wireless terminal is authenticated may be transmitted to the authentication server through a gateway provided or managed by a manufacturing company of the vehicle.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating a method for connecting a wireless terminal to a vehicle according to embodiments of the present disclosure.

FIG. 2 is a view illustrating a process of authenticating the wireless terminal and installing an application for connection in the method for connecting the wireless terminal to the vehicle according to embodiments of the present disclosure.

FIG. 3 is a view illustrating a method for connecting a wireless terminal to a vehicle according to embodiments of the present disclosure.

FIG. 4 is a view illustrating a process of authenticating the wireless terminal and installing an application for connection in the method for connecting the wireless terminal to the vehicle according to embodiments of the present disclosure.

### DETAILED DESCRIPTION

Advantages and features of the present disclosure and methods to achieve them will be described from embodiments described below in detail with reference to the accompanying drawings. However, the present disclosure is not limited to the embodiments set forth herein, but may be modified in many different forms. Merely, the embodiments of the present disclosure will be provided to describe in detail so that those skilled in the art may easily implement the spirit of the present disclosure.

In the drawings, the embodiments of the present disclosure are not limited to specific forms, but are exaggerated for clarity. In the present specification, specific terms have been used, but are just used for the purpose of describing the present disclosure and are not used for qualifying the meaning or limiting the scope of the present disclosure, which is disclosed in the appended claims.

In the present specification, an expression ‘and/or’ is used as a meaning including at least one of components listed before and after the expression. In addition, an expression ‘connected to or coupled to’ is used as a meaning including a case in which one component is directly connected to another component or is indirectly connected through another component. Unless explicitly described to the contrary, a singular form includes a plural form in the present specification. In addition, components, steps, operations, and/or elements mentioned by ‘comprise’ or ‘comprising’ used in the present specification mean the existence or addition of one or more other components, steps, operations, and/or elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods may be executed by at least one controller. The term “controller” may refer to a hardware device that includes a memory and/or a processor. The memory may be configured to store program instructions, and the processor may be configured to execute the program instructions to perform one or more processes which are described further below.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings.

The present disclosure, which discloses contents relating to a connection for data communications between an infortainment system, such as a head unit included in a vehicle, and a wireless terminal which can be authenticated to determine whether or not the wireless terminal is a wireless terminal suitable for connection with the infortainment system. Then, the wireless terminal may be connected to the infortainment system. Here, the infortainment system included in the vehicle is described as the head unit by way of example, and the wireless terminal is described as a smartphone by way of example, for convenience of explanation. However, the infortainment system is not limited to the head unit of the vehicle. Similarly, the wireless terminal is also not limited to the smartphone. Rather, the infortainment system and the wireless terminal as disclosed herein may be embodied in any suitable manner, as would be known to a person of ordinary skill in the art.

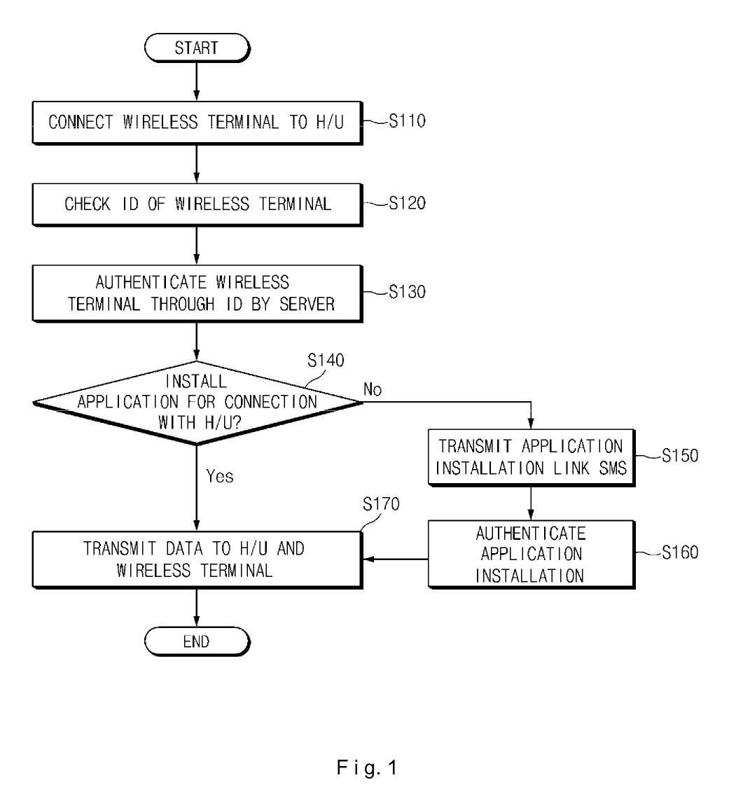

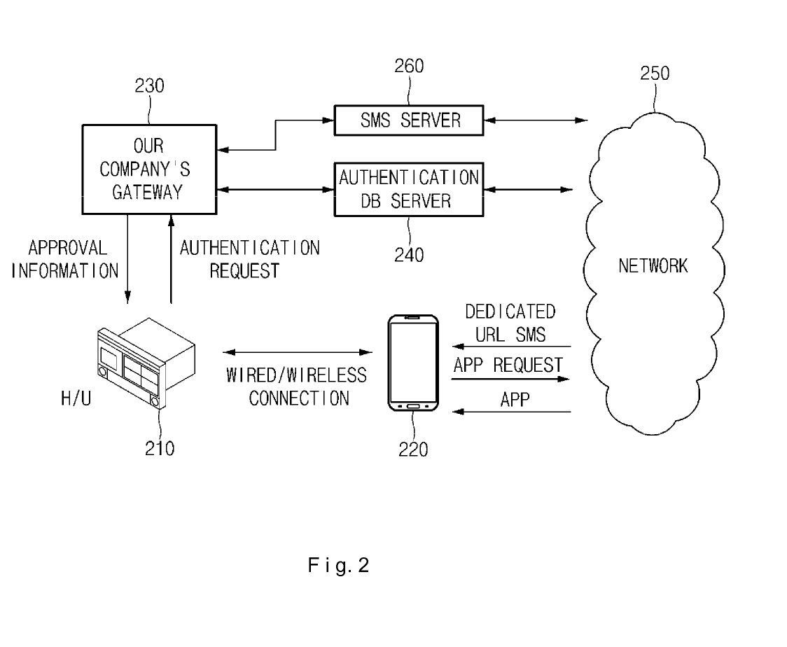

FIG. 1 is a view illustrating a method for connecting a wireless terminal to a vehicle according to embodiments of the present disclosure, and FIG. 2 is a view illustrating a process for authenticating the wireless terminal and installing an application for connecting the wireless terminal to the vehicle according to embodiments of the present disclosure.

First, a head unit 210 and a smartphone 220 are connected wired or wirelessly to each other in order to bidirectionally transmit data, and the connection between the head unit 210 and the smartphone 220 is checked (S110).

Identification (ID) of the smartphone 220 is recognized by the connection between the head unit 210 and the smartphone 220, and the ID is checked in S110 (S120). Here, identification (ID), which is information distinguishing the smartphone 220 from other wireless terminals, may be identification information such as product information of the smartphone 220, a medium access control (MAC) address, and the like.

Next, it is determined whether or not the smartphone 220 having the recognized identification (ID) recognized in S120 is a wireless terminal suitable for connection with the head unit 210. That is, the smartphone 220 is authenticated through a determination of whether or not the smartphone 220 specified by identification (ID) is sufficient to be connected to the head unit 210 (S130).

The method for connecting the wireless terminal to the vehicle according to embodiments of the present disclosure may check whether or not the smartphone 220 is a wireless terminal having a specification (e.g., hardware, software, or the like) which may be connected to the head unit 210, and may also check an operating system (O/S) of the smartphone 220 having the identification (ID). For example, it may be checked whether the operating system (O/S) of the smartphone 220 is manufactured based on Android, based on Intelligent Office System (IOS), or the like. In addition, it may be determined whether or not the smartphone 220 having the recognized identification (ID) has a problem in security. For example, it may be checked whether or not the smartphone 220 having the identification (ID) is or has been hacked or is a routed wireless terminal. In addition, it may be checked whether or not a dedicated application (app) for connection with the head unit 210 is included (i.e., installed) in the smartphone 220 having the identification (ID).

Next, only in the case in which the smartphone 220 having the identification (ID) is the authenticated wireless terminal based on the determined result (i.e., the authenticated result) in S130, the head unit 210 and the smartphone 220 are connected to each other and bidirectional data communications are performed therebetween (S170).

In the method for connecting the wireless terminal to the vehicle according to embodiments of the present disclosure illustrated in FIGS. 1 and 2, authentication of the smartphone 220 is performed by an authentication server 240 (S130). In order for the authentication server 240 to perform the authentication of the smartphone 220, in the method for connecting the wireless terminal to the vehicle according to embodiments of the present disclosure, the identification (ID) recognized in S120 may be transmitted to the authentication server 240.

Next, the authentication server 240 may determine whether or not the smartphone 220 is an authenticated wireless terminal suitable for connection with the head unit 210 of the vehicle through the received identification (ID), and may again transmit the determined authentication result to the head unit 210. Here, a gateway 230 which is provided or managed by a manufacturing company of the vehicle may be present between the head unit 210 of the vehicle and the authentication server 240. The identification (ID) or the determined result may be transferred to each of the head unit 210 of the vehicle and the authentication server 240 through the gateway 230.

In addition, according to the result of the determination in S130, it is determined whether or not the dedicated application for connection with the head unit 210 is installed in the smartphone 220 having the identification (ID) (S140). In the case in which the dedicated application for connection with the head unit 210 is not installed in the smartphone 220, a message including dedicated uniform resource locator (URL) for including (e.g., downloading and installing) the dedicated application may be transmitted to the smartphone 220 (S150). Here, the message may be a short message service (SMS) message transmitted to the smartphone 220 through an SMS server 260 and a network 250, but is not limited thereto. For example, the message may include several kinds of messages performed by data communication.

Next, it is checked whether or not the dedicated application is installed in the smartphone 220 (S160). In the case in which the dedicated application is installed, the data transmission between the head unit 210 and the smartphone 220 is performed (S170). Here, the result that the dedicated application is installed in the smartphone 220 may be stored by updating the determination result which is determined as the authentication in S130.

By the above-mentioned processes, since the method for connecting the wireless terminal to the vehicle according to embodiments of the present disclosure determines the smartphone 220 suitable for connection with the head unit 210 through the authentication procedure and connects only the authenticated smartphone 220 to the head unit 210, a stable connection for data transmission may be established between the smartphone 220 and the head unit 210. In addition, since the method determines whether or not the dedicated application for data transmission or connection is present without a separate manipulation of a user of the smartphone 220, and also transmits the message including the dedicated URL to the smartphone 220 to allow the user to conveniently secure the corresponding dedicated application (i.e., in the case in which the dedicated application is not present based on the determined result), the process for connecting the head unit 210 to the smartphone 220 may be simplified.

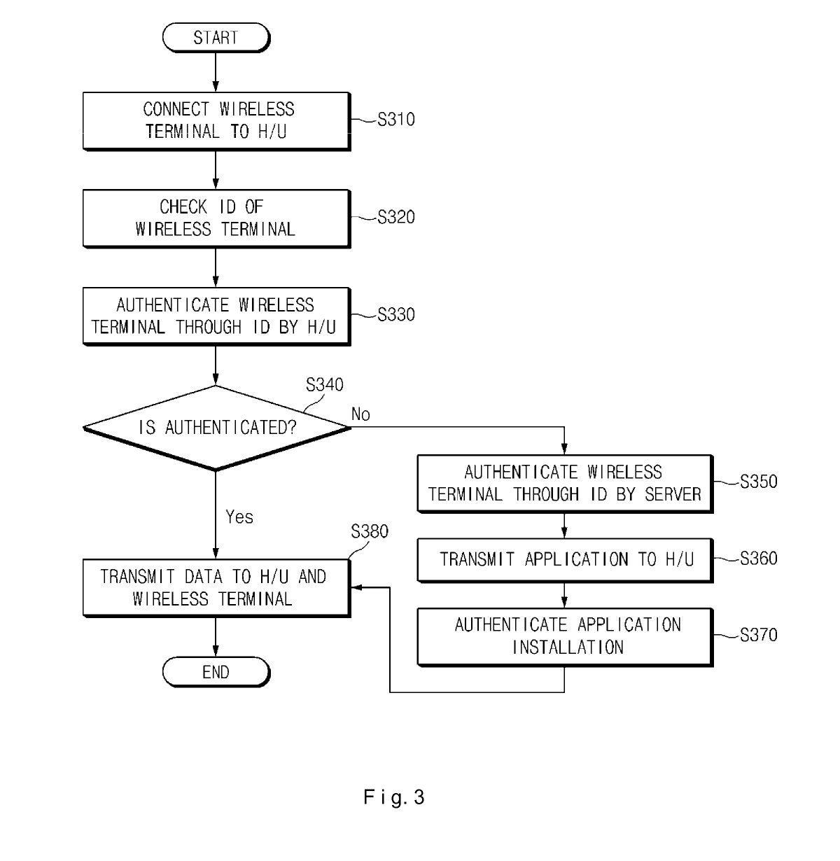

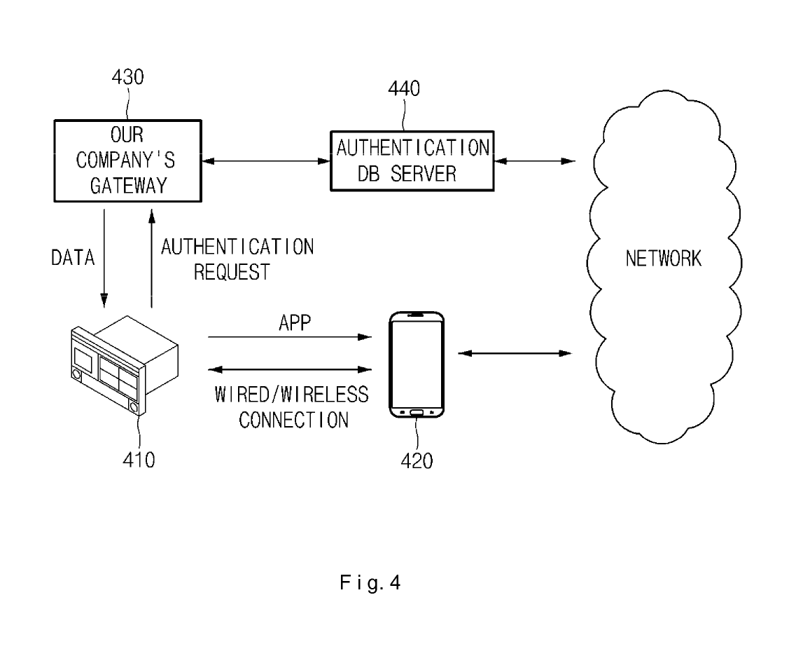

FIG. 3 is a view illustrating a method for connecting a wireless terminal to a vehicle according to embodiments of the present disclosure, and FIG. 4 is a view illustrating a process of authenticating the wireless terminal and installing an application for connection in the method for connecting the wireless terminal to the vehicle according to embodiments of the present disclosure.

First, a head unit 410 and a smartphone 420 are connected wired or wirelessly to each other, and the connection between the head unit 410 and the smartphone 420 is checked (S310). Identification (ID) of the smartphone 420 is recognized by the connection which is checked in S310 (S320). Here, the identification (ID), which is information distinguishing the smartphone 420 from other wireless terminals, may be identification information such as product information of the smartphone 420, a medium access control (MAC) address, and the like.

Next, it is determined whether or not the smartphone 420 having the recognized identification (ID) (recognized in S320) is a wireless terminal suitable for connection with the head unit 410 (S330). Here, since authentication is the same as contents described above with reference to FIGS. 1 and 2, a detailed description thereof will be omitted. In the method for connecting the wireless terminal to the vehicle according to embodiments of the present disclosure illustrated in FIGS. 3 and 4, authentication of the smartphone 420 can be primarily performed by the head unit 410 (S330). Specifically, it may be determined whether or not the smartphone 420 is an authenticated wireless terminal suitable for connection with the head with 410 through an authentication database included in the head unit 410.

Next, only in the case in which the smartphone 420 having the identification (ID) is the authenticated wireless terminal based on the determined result (i.e., the authentication result) in S330, the head unit 410 and the smartphone 420 are connected to each other and bidirectional data communications are performed therebetween (S380). In addition, in the case in which the smartphone 420 having the identification (ID) is not authenticated based on the authentication result in S330 (S340), the corresponding smartphone 420 is secondarily authenticated by an authentication server 440 (S350).

To this end, in the method for connecting the wireless terminal to the vehicle according to embodiments of the present disclosure, the identification (ID) recognized in S320 may be transmitted to the authentication server 440. Next, the authentication server 440 may determine whether or not the smartphone 420 having the identification (ID) is an authenticated wireless terminal suitable for connection with the head unit 410 of the vehicle through the received identification (ID) and may again transmit the determined authentication result to the head unit 410. Here, a gateway 430 which is provided or managed by a manufacturing company of the vehicle may be present between the head unit 410 of the vehicle and the authentication server 440, and the identification (ID) or the determined result of the authentication server 440 may be transferred to the head unit 410 of the vehicle and/or the authentication server 440 through the gateway 430.

In addition, in the case in which the dedicated application for connection with the head unit 410 is not installed in the smartphone 420 having the identification (ID) based on the determined result in S350, the dedicated application to be installed in the smartphone 420 may be transmitted to the head unit 410 (S360). Here, the determined result of the authentication server 440 may also be transmitted to the head unit 410, together with the transmission of the dedicated application. Next, the dedicated application transmitted to the head unit 410 may be transferred to the smartphone so as to be installed in the smartphone 420. Here, the result that the dedicated application is installed in the smartphone 420 may be stored by updating the determination result which is determined in S350.

By the above-mentioned processes, since the method for connecting the wireless terminal to the vehicle according to embodiments of the present disclosure can determine whether the smartphone 420 is suitable for connection with the head unit 410, and an authentication procedure of the smartphone 420 which is not authenticated through the head unit 410 can be performed through the authentication server 440, it may reduce modem communication cost of the head unit 410. In addition, by the above-mentioned authentication procedure, since the method for connecting the wireless terminal to the vehicle according to embodiments of the present disclosure connects only the authenticated smartphone 420 to the head unit 410, a stable connection for data transmission may be established between the smartphone 420 and the head unit 410. In addition, since the method for connecting the wireless terminal to the vehicle may determine whether or not the dedicated application is present without a separate user operation of the smartphone 420 and provide the corresponding dedicated application through the head unit 410 in the case in which the dedicated application is not present based on the determined result, the process of connecting the head unit 410 to the smartphone 420 may be simplified.

As a result, since the method for connecting the wireless terminal to the vehicle according to embodiments of the present disclosure may secure compatibility of connection with the wireless terminal in the vehicle having a product launch cycle relatively longer than that of the wireless terminal and connect only the wireless terminal authenticated through the authentication process to the vehicle, stability of connection for transmitting data may be increased.

As described above, according to embodiments of the present disclosure, the method for connecting the wireless terminal to the vehicle may authenticate the wireless terminal and allow the application necessary to be connected to the head unit to be installed on the wireless terminal based on the authenticated result. In addition, the compatibility of the connection with the wireless terminal in the vehicle having a product launch cycle relatively longer than the wireless terminal may be secured.

Hereinabove, although the present disclosure has been described with reference to embodiments thereof, those skilled in the art will appreciate that various modifications, additions and substitutions of the present disclosure are possible without departing from the scope and spirit of the present disclosure. Accordingly, the scope of the present disclosure is not construed as being limited to the described embodiments but is defined by the appended claims as well as equivalents thereto. Considering the contents as described above, if modifications and alterations of the present disclosure are included in the following claims and a scope equivalent thereto, it is considered that the present disclosure includes these modifications and alterations thereof.

What is claimed is:

1. A method for connecting a wireless terminal to a vehicle, the method comprising:
checking a wired connection or a wireless connection between an infortainment system of the vehicle and the wireless terminal;
recognizing identification of the wireless terminal;
determining whether or not the wireless terminal is authenticated and thus suitable for connection with the infortainment system; and
connecting the wireless terminal to the infortainment system only in a case in which the wireless terminal is authenticated based on a result of the determining of whether or not the wireless terminal is authenticated.

2. The method according to claim 1, wherein the determining of whether or not the wireless terminal is authenticated includes at least one of:
checking whether or not the wireless terminal includes a specification which is connectable to the infortainment system;
checking an operating system (O/S) of the wireless terminal;
checking whether or not the wireless terminal is or has been hacked or routed; and
checking whether or not a dedicated application for connection with the infortainment system is installed in the wireless terminal.

3. The method according to claim 1, wherein the determining of whether or not the wireless terminal is authenticated includes:
transmitting the recognized identification to an authentication server;
determining, by the authentication server, whether or not the wireless terminal is authenticated and thus suitable for connection with the infortainment system; and
transmitting, to the infortainment system, the result of the determining of whether or not the wireless terminal is authenticated.

4. The method according to claim 3, further comprising, in a case in which a dedicated application for connection with the infortainment system is not installed in the wireless terminal:
transmitting a message including a dedicated uniform resource locator (URL) for installing the dedicated application in the wireless terminal;
checking whether or not the dedicated application is installed in the wireless terminal; and
updating the result of the determining of whether or not the wireless terminal is authenticated based on a result of the checking of whether or not the dedicated application is installed in the wireless terminal.

5. The method according to claim 3, wherein the recognized identification or the result of the determining of whether or not the wireless terminal is authenticated is transmitted to the authentication server through a gateway provided or managed by a manufacturing company of the vehicle.

6. The method according to claim 1, wherein the determining of whether or not the wireless terminal is authenticated includes:
determining whether or not the wireless terminal is authenticated and thus suitable for connection with the infortainment system, using an authentication database included in the infortainment system.

7. The method according to claim 6, wherein the determining of whether or not the wireless terminal is authenticated further includes, in a case in which the wireless terminal is not authenticated:
transmitting the recognized identification to an authentication server;
determining, by the authentication server, whether or not the wireless terminal is authenticated and thus suitable for connection with the infortainment system; and
transmitting, to the infortainment system, the result of the determining of whether or not the wireless terminal is authenticated.

8. The method according to claim 7, further comprising, in a case in which a dedicated application for connection with the infortainment system is not installed in the wireless terminal:
transmitting the dedicated application to the infortainment system; and
transferring the transmitted dedicated application from the infortainment system to the wireless terminal such that the dedicated application is installed in the wireless terminal.

9. The method according to claim 8, further comprising:
checking whether or not the dedicated application is installed in the wireless terminal; and
updating the result of the determining of whether or not the wireless terminal is authenticated based on a result of the checking of whether or not the dedicated application is installed in the wireless terminal.

10. The method according to claim 7, wherein the recognized identification or the result of the determining of whether or not the wireless terminal is authenticated is transmitted to the authentication server through a gateway provided or managed by a manufacturing company of the vehicle.
